(19) United States
(12) Patent Application Publication
(10) Pub. No.: US 2019/0373684 A1
(43) Pub. Date: Dec. 5, 2019

(54) COOKING DEVICE AND METHOD FOR PRODUCING A COOKING DEVICE

(71) Applicant: BSH Hausgeräte GmbH, Munich (DE)

(72) Inventors: Jose Maria De la Cuerda Ortin, Zaragoza (ES); Pablo Jesus Hernandez Blasco, Zaragoza (ES); Izaskun Jaca Equiza, Zaragoza (ES); Ignacio Lope Moratilla, Zaragoza (ES); Damaso Martin Gomez, Zaragoza (ES); Maria Elena Moya Albertin, Zaragoza (ES); Carlos Obon Abadia, Zaragoza (ES); Pablo Ruiz Arnal, Zaragoza (ES)

(21) Appl. No.: 16/467,506

(22) PCT Filed: Dec. 12, 2017
(86) PCT No.: PCT/IB2017/057821

§ 371 Date: Jun. 7, 2019

(30) Foreign Application Priority Data
Dec. 23, 2016 (ES) P201631672

(51) Int. Cl. H05B 6/12

(52) U.S. Cl. CPC H05B 6/129; H05B 6/1281

(57) ABSTRACT

A cooking device includes at least two insulation elements and a heating coil which has at least two windings. The heating coil is arranged at least partially between the at least two insulation elements. At least one of the at least two insulation elements, when viewed at least in a direction parallel to a main extension plane of the heating coil, is arranged at least partially between the at least two windings.

The invention is based on a cooking device according to the preamble of claim 1 and a method for producing a cooking device according to the preamble of claim 10.

Cooking appliances with an insulating carrier and a heating coil with a number of windings, wherein the windings are partially encompassed by the carrier, are known from the prior art.

Cooking appliances with two insulation layers and a heating coil arranged between the insulation layers are further known, wherein the insulation layers are connected with the heating coil, for example by means of an adhesive.

The object of the invention is in particular to provide a generic cooking device with improved properties in relation to insulation effect. The object is achieved by the characterizing features of claims 1 and 10, while advantageous embodiments and developments of the invention can be derived from the subclaims.

The invention is based on a cooking device, in particular an oven device and advantageously an induction oven device, with at least two insulation elements, in particular a first insulation element and a second insulation element, and with a least one heating coil, which has at least two, advantageously at least four, preferably at least eight and particularly preferably at least sixteen windings and which at least partially is arranged, preferably at least for the most part and particularly preferably completely, between the insulation elements.

It is recommended that at least one of the insulation elements, in particular the first insulation element and/or the second insulation element, viewed at least in a direction at least essentially parallel to a main extension plane of the heating coil, is arranged at least partially, preferably at least for the most part and particularly preferably completely between the windings, in particular in such a way that the insulation element separates and/or distances the windings from each other. Advantageously, the insulation element here forms a positive form fit with the windings, and/or prevents a movement of the windings relative to each other. The expression “at least for the most part” should here be taken to mean in particular to the extent of at least 55%, advantageously of at least 65%, preferably of at least 75%, particularly preferably of at least 85% and particularly advantageously of at least 95%.

In this connection a “cooking device” should in particular be taken to mean at least a part, in particular a subassembly, of a cooking appliance, in particular a cooktop, a grill appliance, a microwave oven and/or preferably an oven. Advantageously, the cooking appliance is here embodied as an induction cooking appliance, in particular as an induction cooktop, as an induction grill appliance, as an induction microwave oven, and/or particularly preferably as an induction oven. The cooking device preferably comprises at least one heating unit, preferably embodied as an inductor, which comprises at least the heating coil and the insulation elements. In addition, the heating unit is particularly advantageously free from a material, in particular an adhesive, which connects the insulation elements and/or the heating coil to the insulation elements. An “insulation element” should in particular be taken to mean an element which at least partially, preferably at least for the most part and particularly preferably completely, consists of an advantageously electrically insulating material and in particular is provided to insulate the heating coil from a further object and/or to insulate the windings of the heating coil from each other. Advantageously, at least one subarea of the insulation element facing the heating coil here consists of an electrically insulating material. The word “provided” should in particular be taken to mean specially designed and/or equipped. That an object is provided for a particular function should in particular be taken to mean that the object fulfills and/or performs this particular function in at least one usage and/or operating status. Furthermore, a “heating coil” should in particular be taken to mean an advantageously inductive element, in particular an inductive heating element, which in particular comprises a least one, preferably exactly one heating cable, in particular a heating conductor, and in particular has a multiplicity of windings, in particular in a number of planes or advantageously in one plane. Viewed from above, the heating coil can in particular have a circular, oval and/or preferably rectangular form and/or contour. The heating coil could here for example be embodied as a resistance heating element. Advantageously, however, the heating coil is embodied as an induction heating element. In this connection a “winding” of a heating coil should be taken to mean in particular exactly one loop of the heating coil, in particular of the heating cable of the heating coil, through 360°, in particular relative to a central reference point, in particular the center, of the heating coil and in particular when viewed perpendicular to a main extension plane of the heating coil. The phrase “at least essentially parallel” should further in particular be taken to mean an orientation of a direction relative to a reference direction, in particular in one plane, wherein the direction has a deviation vis-à-vis the reference direction in particular of less than 8°, advantageously less than 5° and particularly advantageously less than 2°. The expression “main extension plane” of an object should in particular be taken to mean a plane which is parallel to a largest lateral face of a smallest, in particular notional, cuboid, which only just completely encloses the object, and which in particular runs through a center, in particular a geometric center, of the cuboid.

An insulation effect can in particular be improved by this embodiment. In particular, a separation and in particular an insulation of the windings can also be guaranteed in the case of a high temperature. In addition, in particular efficiency, in particular material efficiency, component efficiency, structural space efficiency, production efficiency, heating efficiency and/or cost efficiency, can be improved. Furthermore, in particular an advantageous heat resistance, in particular of a connection between the heating coil and the insulation elements, can be achieved. Furthermore, by means of the disclosed embodiment, it can be achieved that a connection between windings of the heating coil and the insulation elements is free from material, in particular free from adhesive, so that the heating unit can be constructed preferably exclusively from heat-resistant materials.

It is further recommended that at least one of the insulation elements, in particular the first insulation element and/or the second insulation element, encompasses at least one of the windings, advantageously at least a majority of the windings and particularly preferably all windings in a circumferential direction to an extent of at least 30%, in particular at least 40%, advantageously at least 45%, preferably at least 48% and particularly preferably at least 50%. An effective insulation of the windings from each other and advantageously a stable fixing of the windings can hereby in particular be achieved.

In addition, it is recommended that at least one of the insulation elements, in particular the first insulation element and/or the second insulation element, is embodied in a flat form with a maximum material thickness of at most 0.8 mm, in particular of at most 0.5 mm, preferably of at most 0.3 mm and particularly preferably of at most 0.25 mm. In particular, the material thickness measures at least 0.05 mm, preferably at least 0.1 mm and particularly preferably at least 0.15 mm. An “insulation element in a flat form” should here in particular be taken to mean an insulation element in which a largest lateral face of a smallest, in particular notional, cuboid, which only just completely encloses the insulation element, is larger by at least 50%, advantageously by at least 100%, preferably by at least 200% and particularly preferably by at least 500% than that lateral face of the cuboid arranged perpendicularly to the largest lateral face. A simple structure, low weight and/or simple processing, in particular shaping, of the insulation elements can thereby in particular be enabled.

It is furthermore recommended that at least one of the insulation elements, in particular the first insulation element and/or the second insulation element, contacts the heating coil, in particular at least one of the windings, advantageously at least a majority of the windings and particularly preferably all windings. An effective insulation of the windings can hereby in particular be achieved.

It is further recommended that the insulation elements, in particular the first insulation element and the second insulation element, are in contact with each other, preferably between at least two windings, advantageously between at least the majority of the windings and particularly preferably between all windings. In particular, reliability of the insulation and/or of the fixing of the windings can thereby be improved.

In addition, it is recommended that at least one of the insulation elements, in particular the first insulation element and/or the second insulation element, is embodied in one piece. In this connection, “in one piece” should in particular be taken to mean at least connected in a bonded manner. The bonding can for example be produced by means of an adhesive process, a spray process, a welding process, a soldering process and/or another process. In one piece should advantageously be taken to mean formed from one piece and/or in one piece. This one piece is preferably manufactured from a single blank, a shape and/or a casting, for example in an extrusion method, in particular a single- and/or multi-component extrusion process, and/or in an injection molding method, in particular a single- and/or multi-component injection molding method. A simple and/or low-cost production and/or a high level of stability of the insulation elements can hereby in particular be achieved.

It is further recommended that the insulation elements, in particular the first insulation element and the second insulation element, are connected in one piece. Stability of the insulation elements and/or of the heating unit can thereby be improved and/or an advantageous fixing of the windings of the heating coil achieved.

In addition, it is recommended that the insulation elements, in particular the first insulation element and the second insulation element, are at least essentially structurally identical to each other. Here, “at least essentially structurally identical” objects should in particular be taken to mean objects which have external forms embodied to be at least essentially identical to each other, but which can differ from each other in particular in at least one feature, advantageously an internal structure and/or a manner of functioning. However, disregarding manufacturing tolerances and/or within the framework of production technology possibilities and/or within the framework of standardized tolerances, the at least essentially structurally identical objects are preferably identical to each other. The insulation elements are preferably arranged congruent to each other, at least viewed in a direction perpendicular to the main extension plane of the insulation elements. Low-cost manufacture, low-cost transport and/or low-cost storage of the insulation elements can hereby in particular be achieved. In addition, assembly of the insulation elements and the heating coil can be simplified and/or a compact structure realized.

The invention is further based on a method for producing a cooking device, which has at least two insulation elements, in particular a first insulation element and a second insulation element, and at least one heating coil with at least two, advantageously at least four, preferably at least eight and particularly preferably at least sixteen windings, wherein the heating coil is arranged at least partially, preferably at least for the most part and particularly preferably completely, between the insulation elements.

It is recommended that, in particular in at least one method step, at least one of the insulation elements, in particular the first insulation element and/or the second insulation element, is arranged at least partially, preferably at least for the most part and particularly preferably completely between the windings, at least viewed in a direction parallel to a main extension plane of the heating coil, in particular in such a way that the windings are separated and/or distanced from each other. An insulation effect can in particular be improved by this embodiment. In particular, a separation and in particular an insulation of the windings can also be guaranteed in the case of a high temperature. In addition, in particular efficiency, in particular material efficiency, component efficiency, structural space efficiency, production efficiency, heating efficiency and/or cost efficiency, can be improved. Furthermore, in particular an advantageous heat resistance, in particular of a connection between the heating coil and the insulation elements, can be achieved. Furthermore, by means of the disclosed embodiment, it can be achieved that a connection between windings of the heating coil and the insulation elements is free from material, in particular free from adhesive, so that the heating unit can be constructed preferably exclusively from heat-resistant materials.

In addition, it is recommended that, in particular in at least one method step, at least one of the insulation elements, in particular the first insulation element and/or the second insulation element, is plastically shaped. Consistent shaping of the insulation elements can hereby in particular be achieved.

It is furthermore recommended that, in particular in at least one method step, at least one of the insulation elements, in particular the first insulation element and/or the second insulation element, is in particular impregnated with at least one resin and/or at least one plastic. Flexibility, for example breaking resistance, and/or plasticity of the insulation elements, can in particular hereby be improved.

It is also recommended that for the arrangement of at least one of the insulation elements, in particular of the first insulation element and/or of the second insulation element, between the windings of the heating coil, at least one of the insulation elements, in particular the first insulation element and/or the second insulation element, is subjected to a pressure and/or a temperature, in particular in at least one method step, in particular in such a way that the insulation element is shaped, preferably plastically. In particular, the pressure is greater than an atmospheric pressure, for example at least 1 kg/cm², advantageously at least 5 kg/cm², preferably at least 15 kg/cm², particularly preferably at least 35 kg/cm² and particularly advantageously at least 80 kg/cm². Furthermore, the temperature is in particular higher than a room temperature, for example at least 100° C., advantageously at least 200° C., preferably at least 300° C., particularly preferably at least 450° C. and particularly advantageously at least 600° C. An advantageous shaping of the insulation elements can thereby in particular be achieved.

Further advantages emerge from the following description of the drawing. The drawing shows exemplary embodiments of the invention. The drawing, the description and the claims contain numerous features in combination. The person skilled in the art will expediently also consider the features individually, and put them together into sensible further combinations.

Wherein:

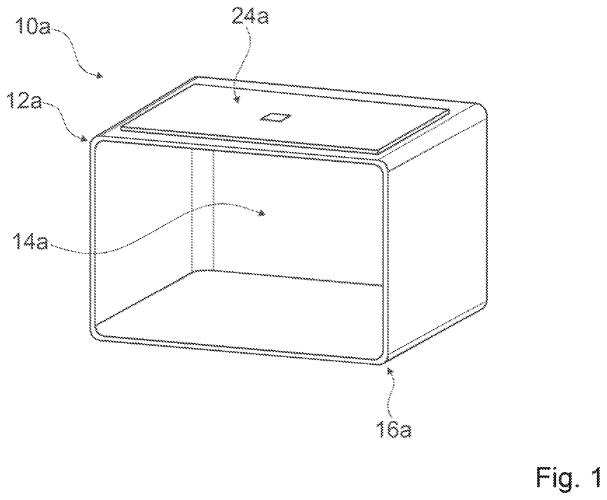

FIG. 1 shows a part of a cooking appliance embodied by way of example as an oven with a cooking device in a schematic representation,

FIG. 2 shows two insulation elements and a heating coil of the cooking device in an exploded diagram,

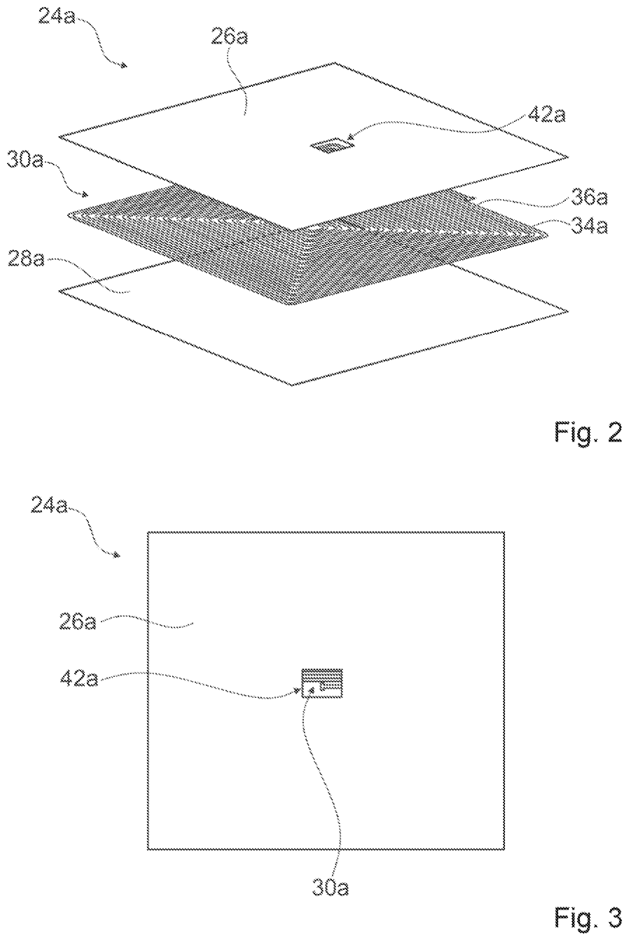

FIG. 3 shows the insulation elements and the heating coil viewed in a direction perpendicular to a main extension direction of the heating unit,

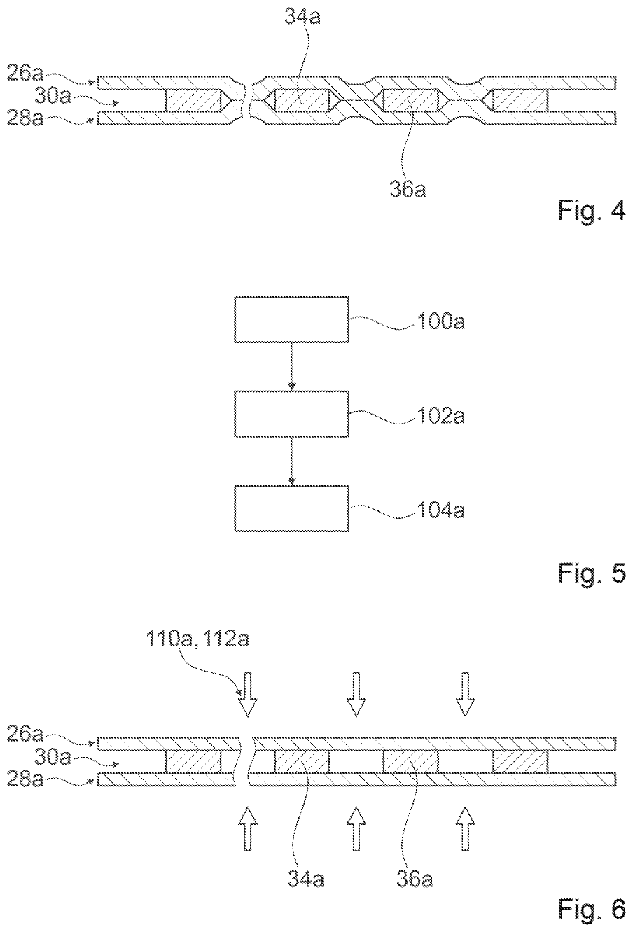

FIG. 4 shows the insulation elements and the heating coil in a cutaway drawing,

FIG. 5 shows an exemplary flow-chart of a method for producing the insulation elements,

FIG. 6 shows the method from FIG. 5 with the insulation elements and the heating coil prior to the insulation elements being subjected to a pressure and a temperature and

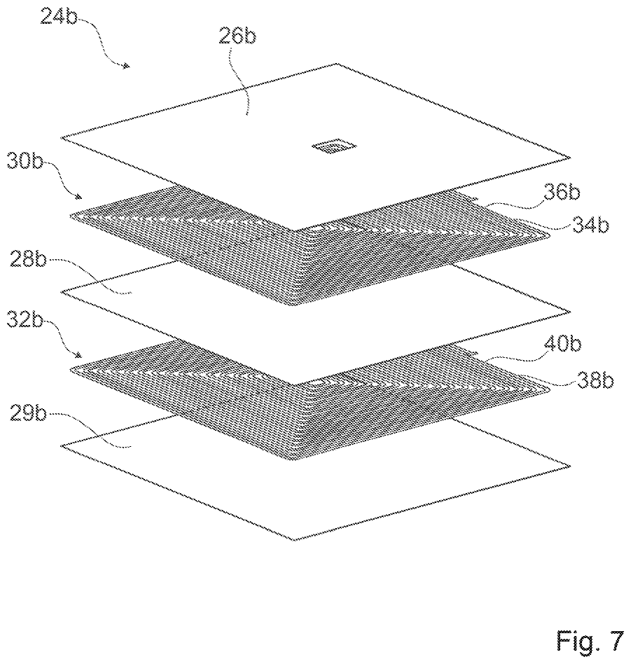

FIG. 7 shows a further exemplary embodiment of a cooking device with two heating coils and three insulation elements in an exploded diagram.

FIG. 1 shows at least a part of a cooking appliance embodied, by way of example, as an oven 10a in a schematic representation. The cooking appliance 10a is embodied as an induction cooking appliance, in the present case in particular as an induction oven. Alternatively, a cooking appliance could be embodied as an induction cooktop, an induction grill appliance and/or as an induction microwave oven. It is however also conceivable that the cooking appliance is embodied as a conventional cooking appliance, for example as a microwave oven.

The cooking appliance 10a comprises a cooking device. The cooking device comprises a cooking device housing 12a (shown only in part). The cooking device housing 12a defines an in particular contiguous cooking compartment 14a. To this end, the cooking device housing 12a comprises an external housing (not shown) and a muffle 16a arranged within the external housing, delimiting the cooking compartment 14a. In addition, the cooking device comprises an appliance closure element (not shown). In the present case the appliance closure element is embodied as an appliance flap. The appliance closure element is provided for closure of the cooking compartment 14a. Alternatively, however, an appliance closure element could also be embodied as an appliance door.

The cooking device further comprises at least one heating unit 24a. The heating unit 24a is integrated into the cooking device housing 12a. The heating unit 24a is arranged between a muffle wall of the muffle 16a and the external housing. The heating unit 24a is here arranged, in particular fixed, on the muffle wall. The heating unit 24a is further embodied in a flat form. In addition, the cooking device can have further heating units, advantageously at least essentially structurally identical to the heating unit 24a, which however for the sake of clarity are not shown in FIG. 1. In particular, a cooking device could here comprise at least two, advantageously at least three and particularly preferably at least four heating units.

In FIG. 2 the heating unit 24a is shown in an exploded diagram. The heating unit 24a is provided to heat foodstuffs to be cooked located in the cooking compartment 14a. To this end, the heating unit 24a comprises a heating coil 30a. The heating coil 30a is embodied as an induction heating element. The heating coil 30a is embodied from a ribbon-like heating conductor, which in the present case in particular has a rectangular cross-section. The heating coil 30a is embodied from a single heating conductor. The heating coil 30a is embodied in copper. The heating coil 30a comprises a multiplicity of windings 34a, 36a. In the present case the heating coil 30a comprises a total of seventeen windings 34a, 36a, wherein for the sake of clarity only two of the windings 34a, 36a are provided with reference characters in the figures. The windings 34a, 36a of the heating coil 30a form a flat coil plane. All windings 34a, 36a of the heating coil 30a are here arranged in the coil plane. In addition, viewed from above, the heating coil 30a has an essentially rectangular form. Alternatively, a heating unit could have a number of heating coils. In addition, a heating coil could have a number of windings differing from seventeen. Viewed from above, a heating coil could further have an essentially circular, oval and/or triangular form.

In particular, in order to enable insulation of the heating coil 30a from the muffle 16a and/or from the external housing, the heating unit 24a further has two insulation elements 26a, 28a, in particular a first insulation element 26a and a second insulation element 28a (cf. in particular FIGS. 2 and 3). The insulation elements 26a, 28a are at least essentially structurally embodied in identical form. The insulation elements 26a, 28a consist of an electrically insulating material, in the present case in particular mica. The insulation elements 26a, 28a are in each case embodied in one piece. The insulation elements 26a, 28a are embodied in a flat form. A maximum material thickness of the insulation elements 26a, 28a here amounts to at most 0.3 mm. In an assembled state the insulation elements 26a, 28a, are arranged on different sides of the heating coil 30a, in particular in relation to the coil plane. A respective main extension plane of the insulation elements 26a, 28a is here arranged parallel to the coil plane. The heating coil 30a is arranged between the insulation elements 26a, 28a. Furthermore, the insulation elements 26a, 28a are in bilateral contact with the heating coil 30a. Alternatively, a cooking device could have more than two insulation elements. Insulation elements could also be embodied in fundamentally different form from each other.

Furthermore, at least one of the insulation elements 26a, 28a, in the present case in particular the first insulation element 26a, has an insulation recess 42a. The insulation recess 42a is here arranged in a central area of the first insulation element 26a, and serves in particular to effect electrical contacting of the heating coil 30a. Alternatively, an insulation recess could be arranged in any other area of an insulation element, for example in a peripheral area and/or in the area of an edge. Furthermore, both insulation elements could also have an insulation recess.

FIG. 4 shows the heating unit 24a in a cutaway drawing in a completely assembled state. Viewed at least in a direction parallel to a main extension plane of the heating coil 30a, the insulation elements 26a, 28a, are here arranged between the windings 34a, 36a. Alternatively, however, just one insulation element could also be arranged between the windings of a heating coil. In the present case, the insulation elements 26a, 28a encompass the windings 34a, 36a in a circumferential direction in each case to an extent of at least 30%, by means of which in particular an advantageous insulation between the windings 34a, 36a of the heating coil 30a can be achieved. In the present case the first insulation element 26a encompasses the windings 34a, 36a to an extent of 50% of a first side of the heating coil 30a. Furthermore, the second insulation element 28a encompasses the windings 34a, 36a to an extent of 50% of a second side of the heating coil 30a. The insulation elements 26a, 28a are here arranged in such a way that the insulation elements 26a, 28a are in contact with each other. In the present case, the insulation elements 26a, 28a are here connected in one piece. Alternatively, however, connection of insulation elements in one piece could also be dispensed with.

FIG. 5 shows an exemplary flow-chart of a method for producing the cooking device.

In a first method step 100a, at least one of the insulation elements 26a, 28a is impregnated with a synthetic resin. Alternatively, however, such an impregnation could also be dispensed with.

In a second method step 102a, the heating coil 30a is positioned between the insulation elements 26a, 28a. The insulation elements 26a, 28a are then plastically shaped. To this end, at least one of the insulation elements 26a, 28a is subjected, at least in a direction parallel to a main extension plane of the heating coil 30a, to an increased pressure 110a, in the present case a pressure of at least 15 kg/cm², and an increased temperature 112a, in the present case a temperature of at least 300° C., so that the insulation elements 26a, 28a wrap around the windings 34a, 36a, in particular in a form-fitted manner (cf. in particular also FIG. 6).

Furthermore, the insulation elements 26a, 28a are cured in a third method step 104a.

FIG. 7 shows a further exemplary embodiment of the invention. The subsequent descriptions and the drawings confine themselves essentially to the differences between the exemplary embodiments, wherein with regard to identically designated components, in particular with regard to components with the same reference characters, reference can also in principle be made to drawings and/or the description of the other exemplary embodiment, in particular from FIGS. 1 to 6. To distinguish between the exemplary embodiments, the letter ‘a’ is suffixed to the reference characters of the exemplary embodiment in FIGS. 1 to 6. In the exemplary embodiment from FIG. 7, the letter ‘a’ is replaced by the letter ‘b’.

The further exemplary embodiment from FIG. 7 differs from the previous exemplary embodiment at least essentially in the embodiment of a heating unit 24b.

In the present case the heating unit 24b comprises two heating coils 30b, 32b and three insulation elements 26b, 28b, 29b, wherein each of the heating coils 30b, 32b is arranged between two of the insulation elements 26b, 28b, 29b. A first insulation element 26b and a third insulation element 29b here outwardly delimit the heating unit 24b.

In addition, at least viewed in a direction parallel to a main extension plane of the heating coils 30b, 32b, at least the first insulation element 26b and the third insulation element 29b are arranged at least between windings 34b, 36b, 38b, 40b of the heating coils 30b, 32b. Alternatively or additionally, a second insulation element 28b, in particular centrally arranged, could likewise be arranged at least partially between the windings 34b, 36b, 38b, 40b of the heating coils 30b, 32b.

### REFERENCE CHARACTERS

10 Cooking appliance
12 Cooking device housing
14 Cooking compartment
16 Muffle
24 Heating unit
26 Insulation element
28 Insulation element
29 Insulation element
30 Heating coil
32 Heating coil
34 Winding
36 Winding
38 Winding
50 Winding
42 Insulation recess
100 Method step
102 Method step
104 Method step
110 Pressure
112 Temperature

1-13. (canceled)

14. A cooking device, comprising:
at least two insulation elements; and
a heating coil including at least two windings and arranged at least partially between the at least two insulation elements, at least one of the at least two insulation elements, when viewed at least in a direction parallel to a main extension plane of the heating coil, being arranged at least partially between the at least two windings.

15. The cooking device of claim 14, wherein at least one of the at least two insulation elements encompasses at least one of the at least two windings in a circumferential direction by at least 30%.

16. The cooking device of claim 14, wherein at least one of the at least two insulation elements is embodied in a flat form with a maximum material thickness of at most 0.8 mm.

17. The cooking device of claim 14, wherein at least one of the at least two insulation elements is in contact with the heating coil.

18. The cooking device of claim 14, wherein the at least two insulation elements are in contact with each other.

19. The cooking device of claim 14, wherein at least one of the at least two insulation elements is embodied in one piece.

20. The cooking device of claim 14, wherein the at least two insulation elements are connected to each other in one piece.

21. The cooking device of claim 14, wherein the at least two insulation elements are at least essentially structurally identical to each other.

22. A cooking appliance, comprising a cooking device, said cooking device comprising at least two insulation elements, and a heating coil including at least two windings and arranged at least partially between the at least two insulation elements, at least one of the at least two insulation elements, at least viewed in a direction parallel to a main extension plane of the heating coil, is arranged at least partially between the at least two windings.

23. The cooking appliance of claim 22, wherein at least one of the at least two insulation elements encompasses at least one of the at least two windings in a circumferential direction by at least 30%.

24. The cooking appliance of claim 22, wherein at least one of the at least two insulation elements is embodied in a flat form with a maximum material thickness of at most 0.8 mm.

25. The cooking appliance of claim 22, wherein at least one of the at least two insulation elements is in contact with the heating coil.

26. The cooking appliance of claim 22, wherein the at least two insulation elements are in contact with each other.

27. The cooking appliance of claim 22, wherein at least one of the at least two insulation elements is embodied in one piece.

28. The cooking appliance of claim 22, wherein the at least two insulation elements are connected to each other in one piece.

29. The cooking appliance of claim 22, wherein the at least two insulation elements are at least essentially structurally identical to each other.

30. A method for producing a cooking device, comprising:
arranging a heating coil at least partially between at least two insulation elements; and
arranging at least one of the at least two insulation elements, at least viewed in a direction parallel to a main extension plane of the heating coil, at least partially between two windings of the heating coil.

31. The method of claim 30, further comprising plastically shaping at least one of the at least two insulation elements.

32. The method of claim 30, further comprising impregnating at least one of the at least two insulation elements.

33. The method of claim 30, further comprising subjecting the at least one of the at least two insulation elements to a pressure and/or a temperature as the at least one of the at least two insulation elements is arranged between the two windings of the heating coil.
